(19) United States
(12) Patent Application Publication
(10) Pub. No.: US 2023/0213188 A1
(43) Pub. Date: Jul. 6, 2023

(54) FLUE SYSTEMS FOR FUEL BURNING DEVICES

(71) Applicant: Rheem Manufacturing Company, Atlanta, GA (US)

(72) Inventors: Emil J. Antoon, Montgomery, AL (US); Prudhvi Amaravadhi, Montgomery, AL (US); Cory Weiss, Warren, MI (US); Kyle Glover, Kinston, NC (US); Walter Snead, Greenville, NC (US)

(21) Appl. No.: 18/150,301

(22) Filed: Jan. 5, 2023

Related U.S. Application Data
(60) Provisional application No. 63/297,006, filed on Jan. 6, 2022.

(51) Int. Cl. F23J 15/00

(52) U.S. Cl. CPC F23J 15/00; F23J 2900/13004

(57) ABSTRACT

An exemplary embodiment of the present disclosure provides a flue gas outlet assembly including a flue gas inlet configured to connect to an exhaust outlet of a fuel burning device, a flue gas outlet, and a flue pipe condensate drain assembly including a condensate inlet, a condensate outlet, and a float valve disposed between the condensate inlet and the condensate outlet, the float valve including a bullet-shaped float, wherein the float valve is biased closed and is configured to open to permit a flow of condensate from the condensate inlet to the condensate outlet upon a sufficient amount of condensate collecting proximate the float valve.

### CROSS-REFERENCE TO RELATED APPLICATION

This application claims priority to and the benefit of U.S. Provisional Patent Application No. 63/297,006, filed Jan. 6, 2022, which is hereby incorporated by reference herein in its entirety.

### FIELD OF THE DISCLOSURE

The present disclosure relates generally to flue systems for fuel burning devices and more particularly to flue systems for condensing-type water heaters.

### BACKGROUND

Fuel burning devices, such as tankless water heaters, create noxious flue gas that must be properly exhausted from a space. If not properly exhausted, flue gas can create dangerous conditions for occupants of the space such as by flue gas escaping from the fuel burning device into the space in which the fuel burning device is installed. Further, if not properly exhausted, flue gas can cause problems with the operation of the fuel burning device. For example, flue gas that backdrafts into a fuel burning device or into the install space can impair the fuel burning devices operation, create dangerous operating conditions, or cause harm to occupants.

While certain after-market solutions exist to mitigate backdraft, such as after-market non-return valves designed to be installed on the exhaust side, such after-market solutions introduce the risk of incorrect installation, which can negatively impact, or even eliminate, the effectiveness of such products.

Further, existing non-return valves designed for the air intake side of a fuel burning device (e.g., a tankless water heater) are designed to prevent the escape of noxious gases out of the air inlet but are generally unable to prevent any backdraft of flue gas into the tankless water heater itself. As mentioned above, this can impair the operation of the water heater or even create dangerous operating conditions.

Therefore, what is needed is an integral flue system for fuel burning devices that is capable of preventing backdraft of flue gas into the fuel burning device or the space in which the fuel burning device is located.

### SUMMARY

The present disclosure relates to flue systems for fuel burning devices. The disclosed technology includes a flue gas outlet assembly. The flue gas outlet assembly can include a flue gas inlet configured to connect to an exhaust outlet of a fuel burning device, a flue gas outlet, and a flue pipe condensate drain assembly. The flue pipe condensate drain assembly can include a condensate inlet, a condensate outlet, and a float valve. The float valve can be disposed between the condensate inlet and the condensate outlet. The float valve can include a bullet-shaped float. The float valve can be biased closed and can be configured to open to permit a flow of condensate from the condensate inlet to the condensate outlet upon a sufficient amount of condensate collecting proximate the float valve.

The float valve can be disposed at a location offset from a central axis of the flue gas inlet or a central axis of the flue gas outlet.

The float valve can be disposed at a periphery of an internal volume of the flue gas inlet or an internal volume of the flue gas outlet.

The bullet-shaped float can be hollow.

The bullet-shaped float can include a first end that is open and a second end that is closed. The second end can have a generally hemispherical shape.

The condensate outlet can be fluidly coupled to a fuel burning device.

The condensate outlet can discharge condensate into a condensate drain of the fuel burning device.

The disclosed technology includes a fuel burning water heater. The fuel burning water heater can include a housing and a flue gas outlet assembly. The housing can include a burner disposed within the housing and a flue gas outlet disposed on the housing. The flue gas outlet can be in fluid communication with the burner. The flue gas outlet assembly can be affixed directly to the housing of the fuel burning water heater. The flue gas outlet assembly can include an inlet chamber, an outlet chamber, and a door. The inlet chamber can be configured to receive flue gas from the flue gas outlet. The door can be disposed between the inlet chamber and the outlet chamber. The door can be configured to selectively permit the flue gas to flow between the inlet chamber and the outlet chamber. The door can be configured to bias closed and to open upon a flow of flue gas from the inlet chamber to the outlet chamber.

The flue gas outlet assembly further can include a flue pipe condensate drain assembly. The flue pipe condensate drain assembly can include a condensate inlet, a condensate outlet, and a float valve. The float valve can be disposed between the condensate inlet and the condensate outlet. The float valve can be biased closed and can be configured to open to permit a flow of condensate from the condensate inlet to the condensate outlet upon a sufficient amount of condensate collecting proximate the float valve.

The float valve can be disposed at a location offset from a central axis of the inlet chamber or a central axis of the outlet chamber.

The float valve can be disposed at a periphery of an internal volume of the inlet chamber or an internal volume of the outlet chamber.

The float valve can include a bullet-shaped float.

The bullet-shaped float can be hollow.

The bullet-shaped float can include a first end and a second end. The first end can be open. The second end can be closed. The second end can have a generally hemispherical shape. The first end can be disposed proximal to the outlet chamber. The second end can be disposed distal the outlet chamber.

The door can include a plurality of flaps.

The door can be a circular door. The circular door can include a semicircular first flap and a semicircular second flap.

The outlet chamber can be fluidly coupled with one or more additional fuel burning devices.

The outlet chamber can be fluidly coupled with a common vent manifold. The common vent manifold can be configured to exhaust flue gas from the fuel burning water heater and one or more additional fuel burning devices.

The disclosed technology includes a water heater system. The water heater system can include a common vent manifold and a plurality of fuel burning water heaters. The common vent manifold can be configured to exhaust flue gas. The plurality of fuel burning water heaters can include a housing. The housing can include a burner disposed within the housing and a flue gas outlet disposed on the housing. The flue gas outlet can be in fluid communication with the burner. The flue gas outlet assembly can be affixed directly to the housing of at least one of the fuel burning water heaters. The flue gas outlet assembly can include an inlet chamber, an outlet chamber, a door, and a flue pipe condensate drain assembly. The inlet chamber can be configured to receive flue gas from the flue gas outlet. The door can be disposed between the inlet chamber and the outlet chamber. The door can be configured to selectively permit the flue gas to flow between the inlet chamber and the outlet chamber. The door can be configured to bias closed and to open upon a flow of flue gas from the inlet chamber to the outlet chamber. The flue pipe condensate drain assembly can include a condensate inlet, a condensate outlet, and a float valve. The float valve can be disposed between the condensate inlet and the condensate outlet. The float valve can be biased closed and can be configured to open to permit a flow of condensate from the condensate inlet to the condensate outlet upon a sufficient amount of condensate collecting proximate the float valve.

The float valve can include a bullet-shaped float.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features can also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides an isometric view of an example flue gas outlet assembly, in accordance with the present disclosure.

FIG. 1B provides a section view of an example flue gas outlet assembly, in accordance with the present disclosure.

FIG. 1C provides an exploded plan view of an example flue gas outlet assembly, in accordance with the present disclosure.

FIG. 1D provides an exploded section view of an example flue gas outlet assembly, in accordance with the present disclosure.

FIG. 2A provides an isometric view of an example inlet chamber, in accordance with the present disclosure.

FIG. 2B provides a top view of an example inlet chamber, in accordance with the present disclosure.

FIG. 2C provides a bottom view of an example inlet chamber, in accordance with the present disclosure.

FIG. 3A provides an isometric view of an example outlet chamber, in accordance with the present disclosure.

FIG. 3B provides a top view of an example outlet chamber, in accordance with the present disclosure.

FIG. 3C provides a bottom view of an example outlet chamber, in accordance with the present disclosure.

FIG. 3D provides an isometric section view of an example outlet chamber, in accordance with the present disclosure.

FIG. 3E provides a section view of an example outlet chamber, in accordance with the present disclosure.

FIG. 4A provides an isometric view of an example float, in accordance with the present disclosure.

FIG. 4B provides a plan view of an example float, in accordance with the present disclosure.

FIG. 4C provides a section view of an example float, in accordance with the present disclosure.

FIG. 5 provides a section view of an example flue gas outlet assembly attached to a fuel burning device housing, in accordance with the present disclosure.

FIG. 6A provides an isometric view of an example gasket, in accordance with the present disclosure.

FIG. 6B provides a section view of an example gasket, in accordance with the present disclosure.

FIG. 7A provides an isometric view of an example flap, in accordance with the present disclosure.

FIG. 7B provides a top view of an example inlet chamber having flaps in an open configuration, in accordance with the present disclosure.

FIG. 7C provides a top view of an example inlet chamber having flaps in a closed configuration, in accordance with the present disclosure.

### DETAILED DESCRIPTION

Throughout this disclosure we describe flue systems for fuel burning devices such as a tankless water heater with integral non-return valve at the flue gas outlet. As such, this tankless water heater can prevent backdraft of flue gas into the tankless water heater and into the space in which the tankless water heater is located.

While the disclosed technology is described throughout this disclosure in relation to tankless water heaters, those having skill in the art will recognize that the disclosed technology is not so limited and can be applicable to other scenarios and applications. For example, it is contemplated that the disclosed technology can be applicable to any fuel burning device, such as furnaces, boilers, tank water heaters, appliances, and heating, ventilation, and air conditioning (HVAC) systems.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Indeed, it is to be understood that other examples are contemplated. Many suitable components that would perform the same or similar functions as components described herein are intended to be embraced within the scope of the disclosed devices and methods. Such other components not described herein may include, but are not limited to, for example, components developed after development of the disclosed technology.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified. Further, it is contemplated that the disclosed methods and processes can include, but do not necessarily include, all steps discussed herein. That is, methods and processes in accordance with the disclosed technology can include some of the disclosed while omitting others.

Throughout the specification and the claims, the following terms take at least the meanings explicitly associated herein, unless otherwise indicated. The term “or” is intended to mean an inclusive “or.” Further, the terms “a,” “an,” and “the” are intended to mean one or more unless specified otherwise or clear from the context to be directed to a singular form. By “comprising,” “containing,” or “including” it is meant that at least the named element, or method step is present in article or method, but does not exclude the presence of other elements or method steps, even if the other such elements or method steps have the same function as what is named.

As used herein, unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Although the disclosed technology may be described herein with respect to various systems and methods, it is contemplated that embodiments or implementations of the disclosed technology with identical or substantially similar features may alternatively be implemented as methods or systems. For example, any aspects, elements, features, or the like described herein with respect to a method can be equally attributable to a system. As another example, any aspects, elements, features, or the like described herein with respect to a system can be equally attributable to a method.

To facilitate an understanding of the principles and features of the present disclosure, various examples of the disclosed technology are explained herein. Reference is made in detail herein to the disclosed technology, examples of which are illustrated in the accompanying drawings and disclosed herein. Wherever convenient, the same reference numbers will be used throughout the drawings to refer to the same or like parts. The components, steps, and materials described herein as making up various elements of the disclosed technology are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Referring now to the drawings, in which like numerals represent like elements, examples of the present disclosure are herein described. As will be described in greater detail, the present disclosure can include flue systems for fuel burning devices.

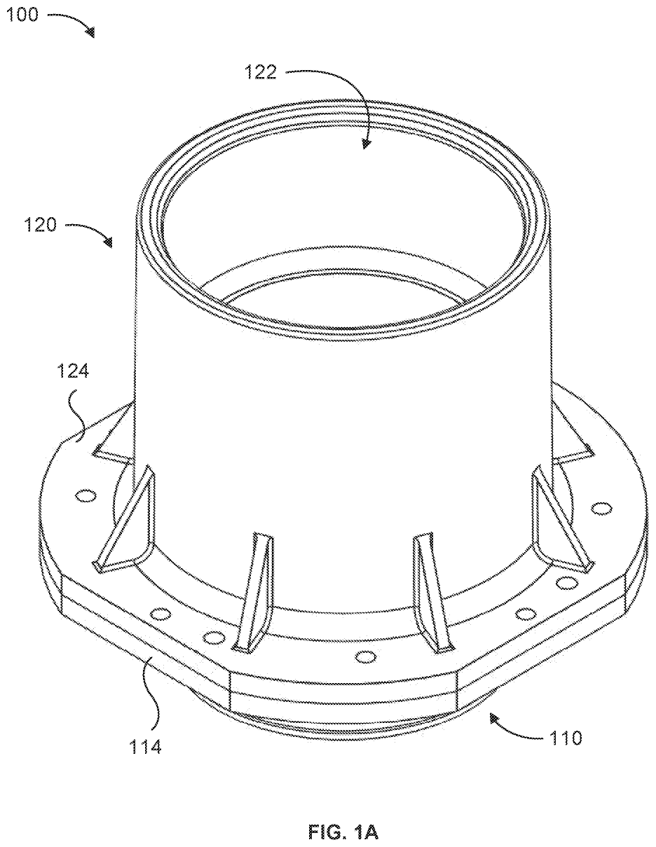

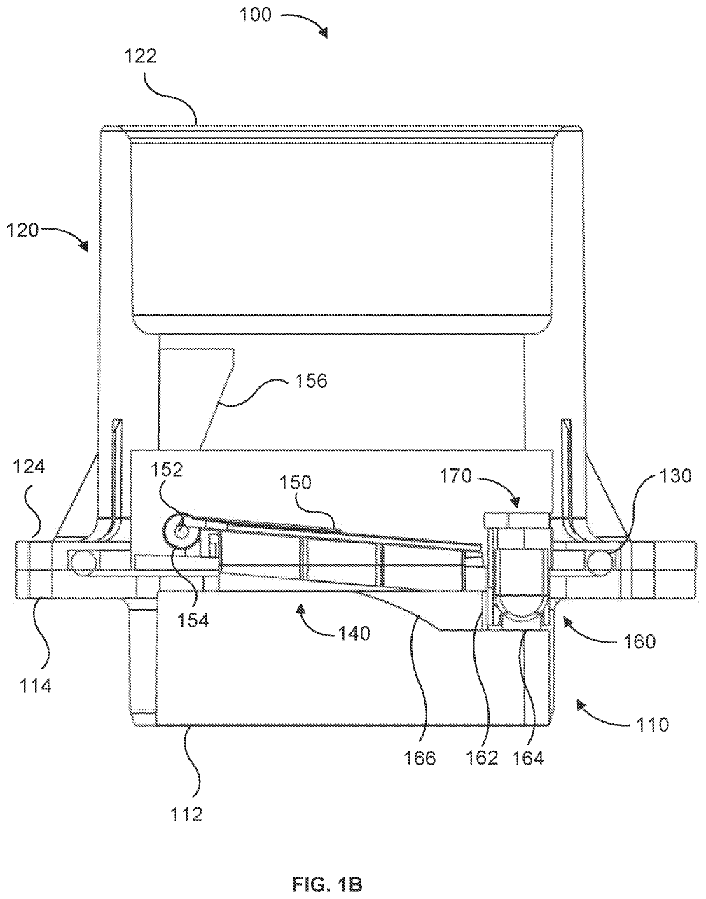

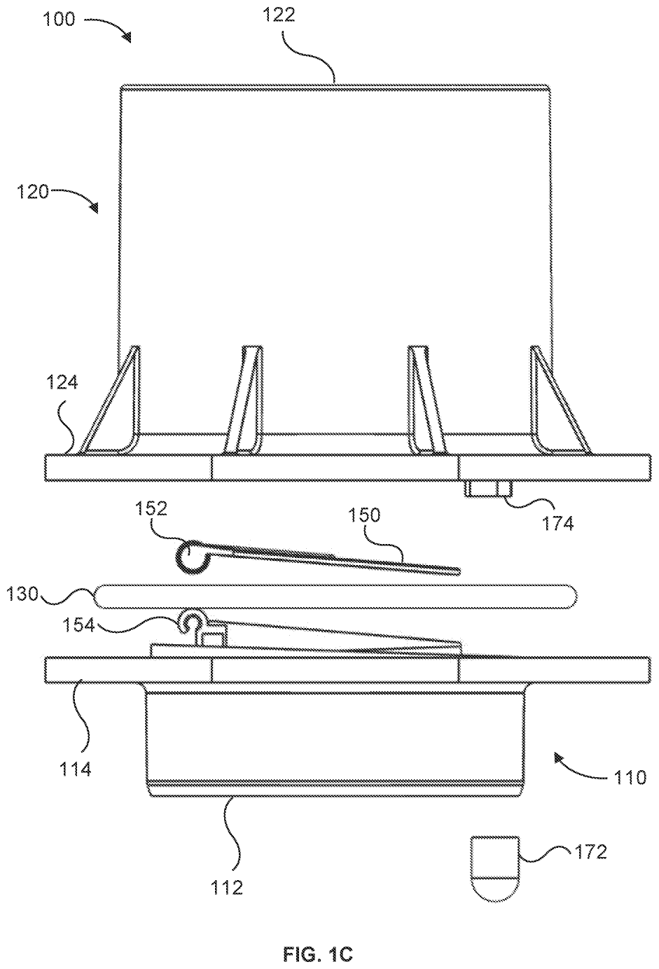

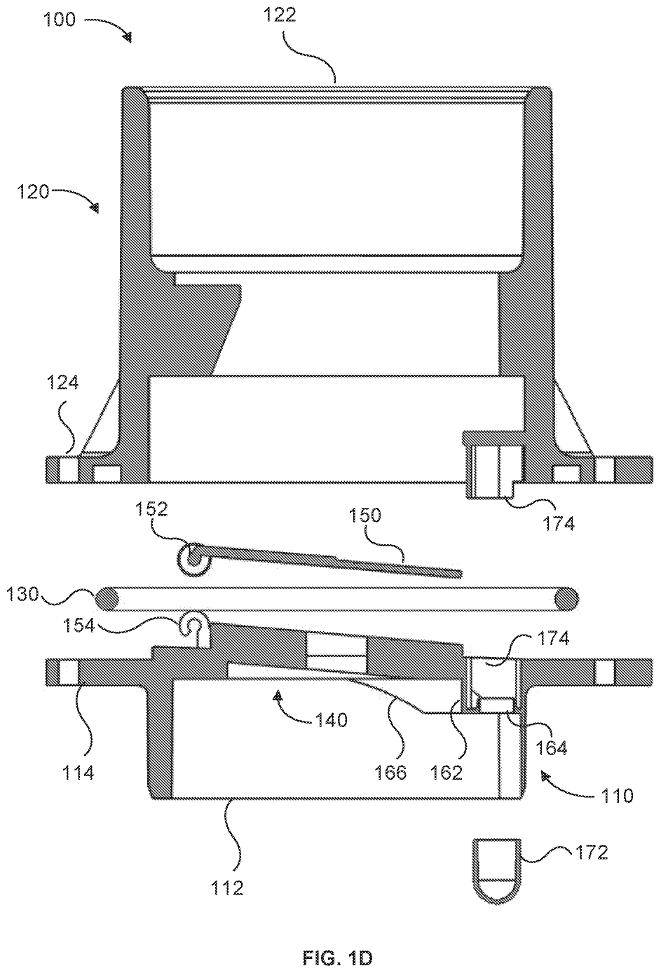

As shown in FIGS. 1A-1D, the disclosed technology includes a flue gas outlet assembly 100. For example, the flue gas outlet assembly 100 can include a non-return valve, and as explained more fully herein, the flue gas outlet assembly 100 can prevent flue gas from flowing back through the outlet of a fuel burning device and into the device. The flue gas outlet assembly 100 can be integral with the fuel burning device and/or attached to the flue gas outlet of the fuel burning device. For example, the flue gas outlet assembly 100 can be integral with a tankless water heater. In addition, one or more flue gas outlet assemblies 100 can be used with one or more fuel burning devices that are in fluid communication with each other. For example, multiple tankless water heaters connected to a common vent manifold can each have a dedicated integral flue gas outlet assembly 100.

In addition, the flue gas outlet assembly 100 can be attached to, or integral with, a fuel burning device without compromising the total venting length of the system and performance of the system. For example, the flue gas outlet assembly 100 can be attached to, or integral with, a tankless water heater such that the vent length of the system—which includes the length of the flue gas outlet assembly 100—can have vent lengths provided in Table 1. Stated otherwise, the combined length of the flue gas outlet assembly 100 and any addition venting (e.g., a straight pipe) can be less than or equal to the values provided in Table 1.

TABLE 1
Maximum Vent Length (intake/exhaust)

| Number of | Maximum Length | | Maximum Length | |
|---|---|---|---|---|
| 90″ Eboss | of 2″ Straight Pipe | | of 3″ Straight Pipe | |
| 0 | 70 ft | (21.3 m) | 150 ft | (45.7 m) |
| 1 | 64 ft | (19.5 m) | 145 ft | (44.2 m) |
| 2 | 58 ft | (17.7 m) | 140 ft | (42.7 m) |
| 3 | 52 ft | (15.8 m) | 135 ft | (41.1 m) |
| 4 | 46 ft | (14.0 m) | 130 ft | (39.6 m) |
| 5 | 40 ft | (12.2 m) | 125 ft | (38.1 m) |
| 6 | 34 ft | (10.4 m) | 120 ft | (36.6 m) |

In addition, where one or more fuel burning devices are commonly vented, each fuel burning device can include a flue gas outlet assembly 100 (e.g., attached to, or integral with, a corresponding fuel burning device) without compromising the total venting length of the system and performance of the system. For example, a plurality of flue gas outlet assemblies 100 can be each integral with a plurality of tankless water heaters with a common vent, wherein the system can have vent lengths provided in Table 2. That is to say, the combined length of each flue gas outlet assembly 100 and the common vent can be less than or equal to the values provided in Table 2.

TABLE 2
Maximum Vent Length (air intake and exhaust) each:

| Number of | 6″ Common | 8″ Common | 10″ Common |
|---|---|---|---|
| water heaters | Vent | Vent | Vent |
| 2 | 70′ (21 m) | 100′ (30 m) | 100′ (30 m) |
| 3 | 50′ (15 m) | 100′ (30 m) | 100′ (30 m) |
| 4 | 40′ (12 m) | 100′ (30 m) | 100′ (30 m) |
| 5 | N/A | 100′ (30 m) | 100′ (30 m) |
| 6 | N/A | 78′ (24 m) | 100′ (30 m) |
| 7 | N/A | 55′ (17 m) | 100′ (30 m) |
| 8 | N/A | 43′ (13 m) | 100′ (30 m) |
| 9 | N/A | N/A | 100′ (30 m) |
| 10 | N/A | N/A | 85′ (26 m) |

Equivalent Vent Length:

| | 6″ Common | 8″ Common | 10″ Common |
|---|---|---|---|
| | Vent | Vent | Vent |
| 87 Degree | 8.0′ (2.4 m) | 5.0′ (1.5 m) | 5.0′ (1.5 m) |
| Elbow | | | |
| 48 Degree | 4.0′ (1.2 m) | 2.5′ (0.8 m) | 2.5′ (0.8 m) |
| Elbow | | | |

The flue gas outlet assembly 100 can include an inlet portion (e.g., an inlet chamber 110) and an outlet portion (e.g., an outlet chamber 120). The inlet chamber 110 and outlet chamber 120 can be hollow members, such as sections of flue pipe, with one or more openings for receiving and discharging flue gas. For example, the inlet chamber 110 can attach to and/or receive flue gas from a fuel burning device, and the outlet chamber 120 can attach to and/or discharge flue gas to an exhaust, vent, or flue system.

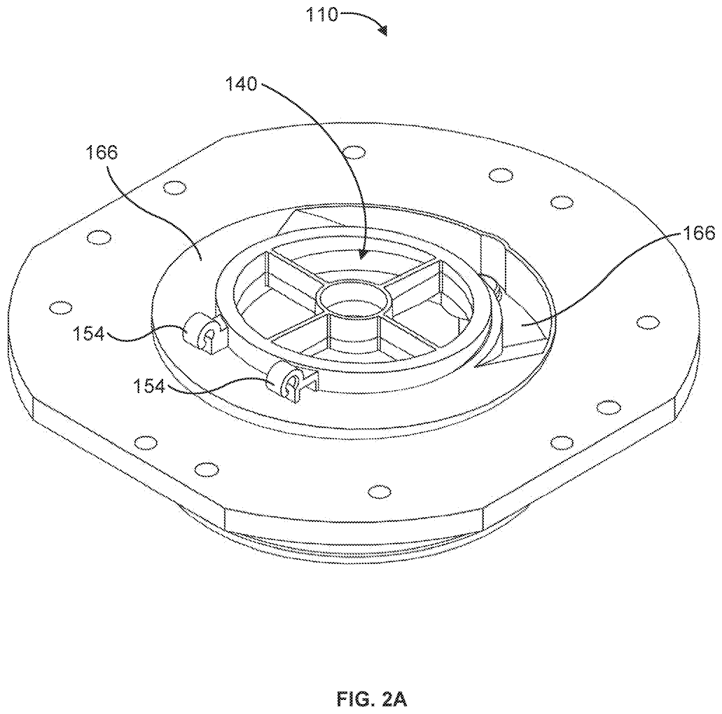

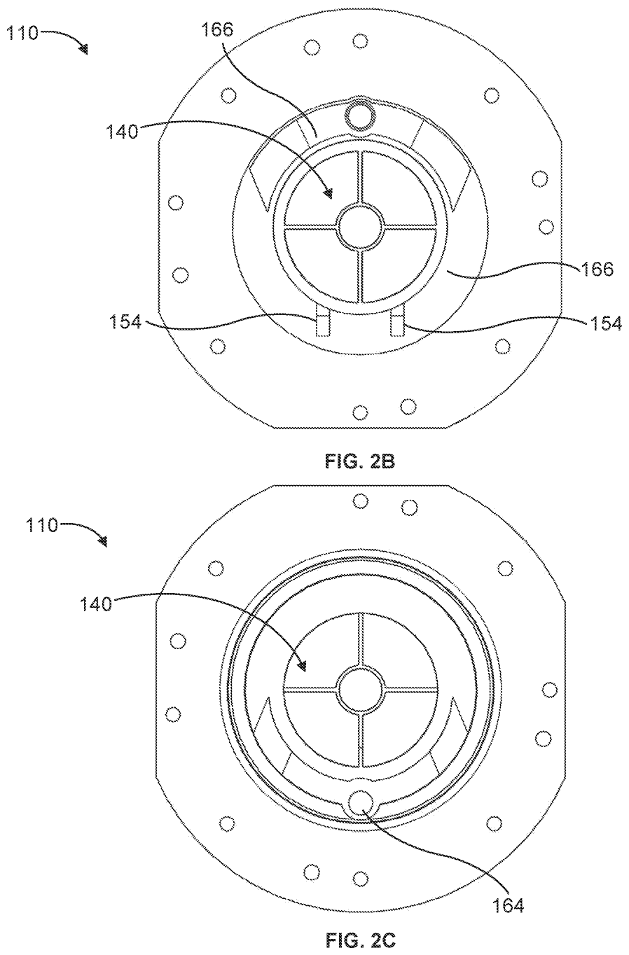

The inlet chamber 110 (also shown separately in FIGS. 2A-2C) can include an inlet opening 112 configured to receive flue gas from a fuel burning device. In addition, the inlet chamber 110 can include an inlet chamber flange 114. As illustrated in FIG. 1B, the inlet opening 112 can be disposed at a proximal end of the inlet chamber 110, and the inlet chamber flange 114 can be disposed at a distal end of the inlet chamber 110.

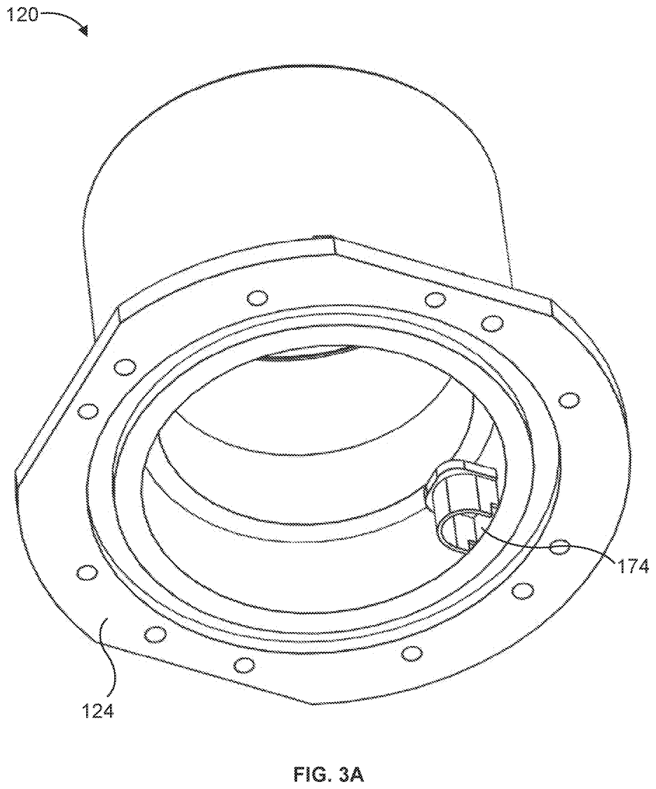

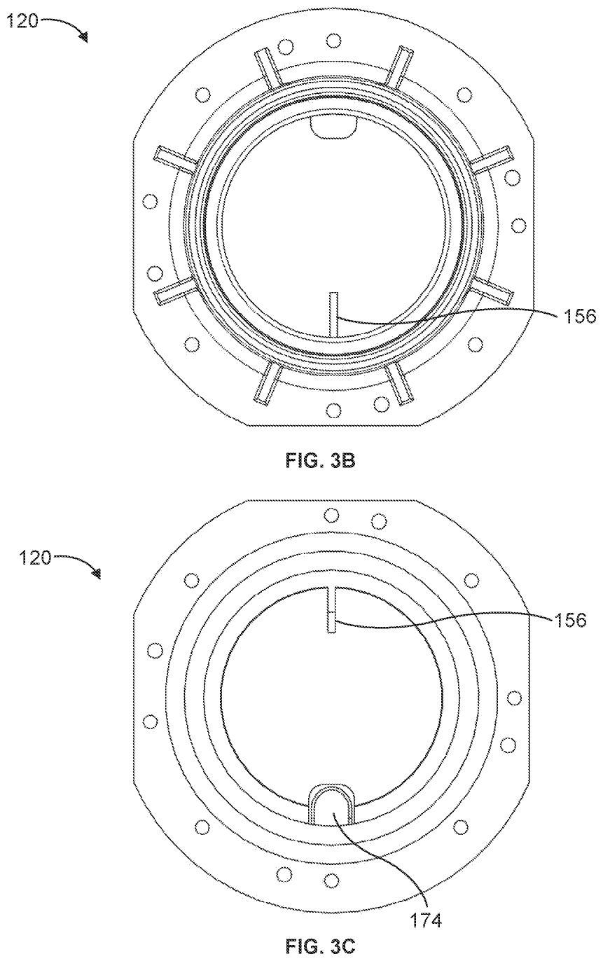

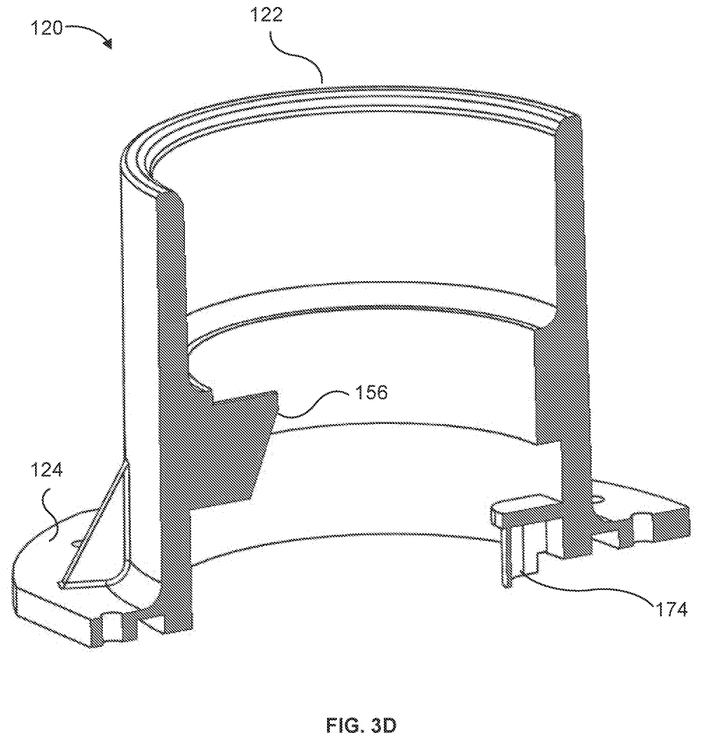

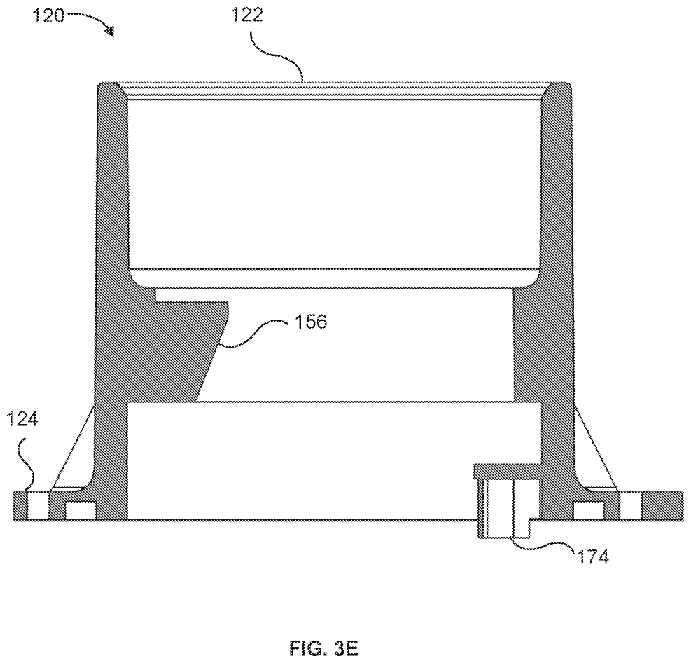

The outlet chamber 120 (also shown separately in FIGS. 3A-3E) can include an outlet opening 122 configured to discharge flue gas to an exhaust, vent, or flue system. In addition, the outlet chamber 120 can include an outlet chamber flange 124. As illustrated in FIG. 1B, the outlet opening 122 can be disposed at a proximal end of the outlet chamber 120 and the outlet chamber flange 124 can be disposed at a distal end of the outlet chamber 120.

As illustrated in FIGS. 1A-1D, the inlet chamber flange 114 can be configured to abut the outlet chamber flange 124. For example, the inlet chamber 110 can be connected to the outlet chamber 120 by connecting the inlet chamber flange 114 to the outlet chamber flange 124. For example, the inlet chamber flange 114 and outlet chamber flange 124 can be connected by any attachment method known in the art, including, but not limited to, bolts, screws, pins, rivets, adhesive, welding, and the like, or any combination thereof. Alternatively, the inlet chamber 110 and outlet chamber 120 can be configured to be a single structure. For example, the inlet chamber 110 and outlet chamber 120 can be constructed together during fabrication, such as by molding or additive manufacturing techniques. Alternatively, or in addition, the flue gas outlet assembly 100 can include an O-ring 130. As illustrated in FIG. 1B, the O-ring 130 can be disposed between the inlet chamber flange 114 and the outlet chamber flange 124. For example, the O-ring 130 can create an airtight seal between the inlet chamber flange 114 and the outlet chamber flange 124.

The flue gas outlet assembly 100 can include an opening 140 disposed between the inlet chamber 110 and the outlet chamber 120. For example, the opening 140 can be an opening between the inlet chamber 110 and outlet chamber 120 such that the inlet chamber 110 and outlet chamber 120 are in fluid communication through the opening 140. Flue gas can travel through the opening 140. As explained more fully herein, some or all of the internal cavity of the inlet chamber 110 can be in selective fluid communication with some or all of the internal cavity of the outlet chamber 120, such as via the door 150, described more fully herein.

The flue gas outlet assembly 100 can include a door 150. The door 150 can be disposed between the inlet chamber 110 and the outlet chamber 120. The door 150 can be configured to open and close the opening 140. Stated otherwise, the door 150 can enable the inlet chamber 110 to be in selective fluid communication with the outlet chamber 120. For example, the door 150, when closed, can create a barrier between the inlet chamber 110 and the outlet chamber 120. The barrier created by the door 150 in the closed position can prevent the flow of flue gas from the outlet chamber 120 to the inlet chamber 110. In addition, the door 150, when open can allow the flow of flue gas from the inlet chamber 110 to the outlet chamber 120. For example, the door 150 can be in an open position where the door is rotated such that it no longer creates a barrier between the inlet chamber 110 and the outlet chamber 120. The door 150 can open upon a flow of flue gas from the inlet chamber 110 to the outlet chamber 120. The door 150 can be configured in a size and shape that covers the entirety of the opening 140. For example, the opening 140 can be circular and the door 150 can be circular, having a similar or larger diameter than that of the opening 140.

The door 150 can be configured to bias closed. For example, the door 150 can be biased closed by gravity exerting a passive force on the door 150 to be in a closed position. The force of gravity can be overcome by the differential air pressure caused by the flow of flue gas from the inlet chamber 110 to the outlet chamber 120 to allow the door 150 to open. Alternatively, or in addition, the door 150 can be biased closed by a spring. For example, the door 150 can include a spring member that can passively exert a force on the door 150 to be in a closed position. The spring member can exert a force that can be overcome by the differential air pressure caused by the flow of flue gas from the inlet chamber 110 to the outlet chamber 120 to allow the door 150 to open. Optionally, the spring can be located at or within the hinge portion of the door 150, although other spring configurations are contemplated. Alternatively, or in addition, the door 150 can be motorized and controllably opened and closed. For example, the door 150 can be controlled by a controller. The controller can be a dedicated controller for the flue gas outlet assembly 100 and/the controller can be included (or be in communication with) the fuel burning device (e.g., water heater, HVAC system). That is, the controller for the flue gas outlet assembly 100 can be a dedicated controller, a controller for a central system, a locally located controller, a remotely located controller (e.g., backend server), and the like, or any combination thereof.

The door 150 can include a hinge configured to allow the door to rotate open and closed. The hinge can be any hinge known in the art. For example, as illustrated in FIGS. 1B-1D, the door 150 can include a hinge having one or more pins 152 and knuckles 154.

The flue gas outlet assembly 100 can include a door stop 156. As illustrated in FIG. 1B, the door stop 156 can be an angled member protruding from the interior of the outlet chamber 120 and configured to stop the door 150 from opening past a certain angle.

The flue gas outlet assembly 100 can include a condensate drain assembly 160. The condensate drain assembly 160 can include a condensate inlet 162 (e.g., a condensate collection port) and a condensate outlet 164. The condensate inlet 162 can be disposed within the interior of the outlet chamber 120 and the condensate outlet 164 can be disposed within the interior the inlet chamber 110. For example, the condensate inlet 162 can receive condensate from the outlet chamber 120 and the condensate outlet 164 can discharge condensate into the inlet chamber 110. Alternatively, or in addition, the condensate outlet 164 can be fluidly coupled to a fuel burning device. For example, the condensate outlet 164 can be configured to fluidly connect to a condensate drain of the fuel burning device (e.g., by a condensate tube, being aligned with the condensate drain, or the like).

In addition, the condensate drain assembly 160 can include a condensate channel 166. The condensate channel 166 can collect condensate in the outlet chamber and direct the flow of that condensate to the condensate inlet 162. For example, the condensate channel 166 can be a channel disposed around at least a portion of the opening 140 and sloped towards the condensate inlet 162. The channel 166 can be located at or near a periphery of the outlet chamber's 120 internal cavity. For example, the channel 166 can be a circular channel that extends around the periphery of the outlet chamber's 120 internal cavity and is sloped towards the condensate inlet 162. The sloping of the channel can vary. For example, the sloping of the channel 166 can increase for a portion of the channel 166 near the condensate inlet.

The condensate drain assembly 160 can include float valve 170. As illustrated in FIG. 1B, the float valve 170 can be disposed between the condensate inlet 162 and the condensate outlet 164. The float valve 170 can be configured to bias closed preventing the flow of fluid or flue gas through the condensate drain assembly 160. For example, the float valve 170 can be biased closed due to gravity. The float valve 170 can further be configured to open to permit a flow of condensate from the condensate inlet 162 to the condensate outlet 164 upon a sufficient amount of condensate collecting proximate the float valve 170. The float valve 170 can include a float 172. For example, the float 172 can be configured so that it is buoyant in a fluid, such as condensate. The float 172 can be hollow. Alternatively, or in addition, the float 172 can have an opening. For example, the float 172 can be a hollow float with an opening in the top. Alternatively, or in addition, the float 172 can be formed at least partially from a buoyant material. As such, the float valve 170 can remain closed due to gravity and open when the float 172 is buoyantly raised by condensate collecting proximate the float valve 170.

In addition, the float valve 170 can include a float valve housing 174. The float valve housing 174 can be a structure in which the float 172 is located. The float valve housing 174 can allow the float 172 to move up and down based on buoyancy caused by condensate in the condensate drain assembly and further prevent movement of the float 172 in other directions.

The float valve 170 can prevent the flow of flue gas through the condensate drain assembly by the float valve remaining closed until condensate flows from the outlet chamber 120 to the inlet chamber 110. When the float valve is opened in this manner, the flow of condensate from the outlet chamber 120 to the inlet chamber 110 will prevent a flow of flue through the condensate drain assembly 160. Additionally, the float valve 170 can allow for condensate to drain through the condensate drain assembly 160 regardless of whether the door 150 is open or closed. Similarly, the door 150 can freely open and close regardless of whether the float valve 170 is open or closed.

The float valve 170 can be disposed outside the center axis of the flue gas outlet assembly 100. For example, the float valve 170 can be disposed outside the opening 140. More specifically, the float valve 170 can be located at or near a periphery of the inlet chamber's 110 internal cavity and/or at or near a periphery of the inlet chamber 110 itself. Alternatively, the float valve 170 can be disposed at the center axis of the condensate drain assembly 160. For example, the float valve 170 can be disposed at the center of the opening 140.

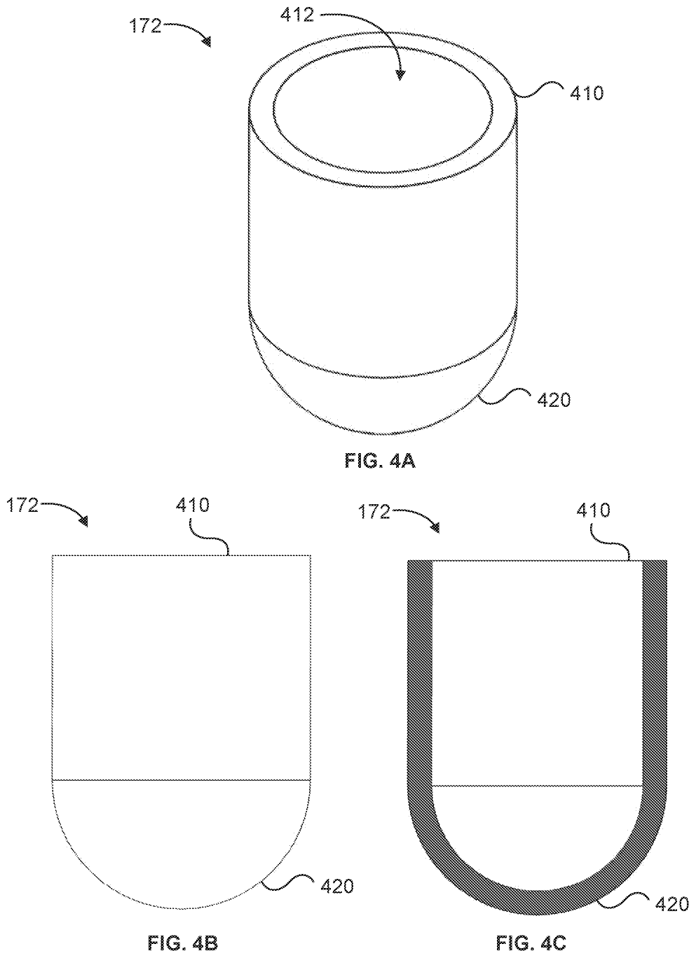

The float 172 can be a bullet-shaped float (e.g., a partial ovoid shape). Alternatively, the float 172 can be a pill-shaped float (e.g., a generally ovoid shape), a generally round or spherical float, a saucer-shaped float, a pillow-shaped float, or a cylindrical float, as nonlimiting examples. As shown in FIGS. 4A-4C, the float 172 can be a bullet-shaped float having a generally cylindrical body with a flat top and rounded bottom. Stated otherwise, the float 172 can have a generally ovoid shape and one end of the float 172 can be generally flat. For example, as illustrated in FIGS. 4A-4C, the bullet-shaped float 172 can include a first end 410 (e.g., a flat top) and a second end 420 (e.g., a rounded bottom). The first end can be generally flat. In addition, the first end 410 can include an opening 412 in the float 172 (e.g., an opening into a hollow float 172). Alternatively, the first end 410 can be closed. As illustrated in FIGS. 4A-4C, the second end 420 can be a closed end with a hemispherical shape. The first end 410 can be disposed proximal to the outlet chamber 120 and the second end 420 can be disposed distal to the outlet chamber 120.

The bullet-shape of the float 172 was found to reduce the density and mass of the float 172 when compared to conventional floats such as ball floats. Additionally, the bullet-shape of the float 172 was found to reduce back pressure as the condensate drains through the condensate drain assembly 160. For example, the bullet-shape of the float 172 can funnel condensate in such a way that it creates an upward force on the float 172 to allow the condensate to drain down. The bullet-shape of the float 172 can allow the float valve 170 to open and close for condensate to drain through the condensate drain assembly 160 regardless of whether the door 150 is open or closed by preventing pressure differentials from the flue gas acting on the float valve to seal it closed, which is not possible with traditional, spherical floats. Similarly, the door 150 can freely open and close regardless of whether the float valve 170 is open or closed.

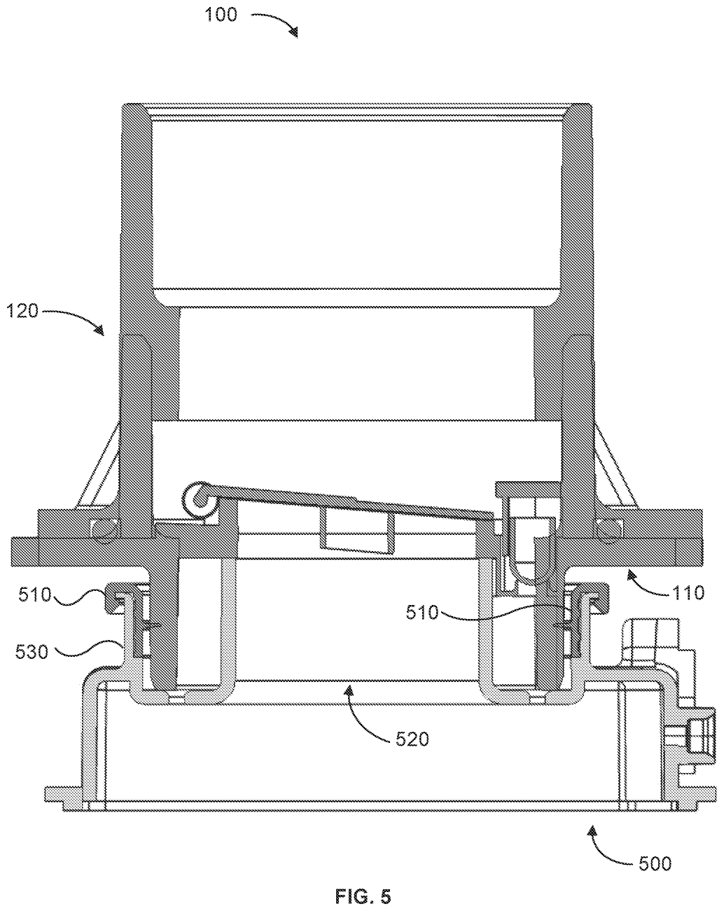

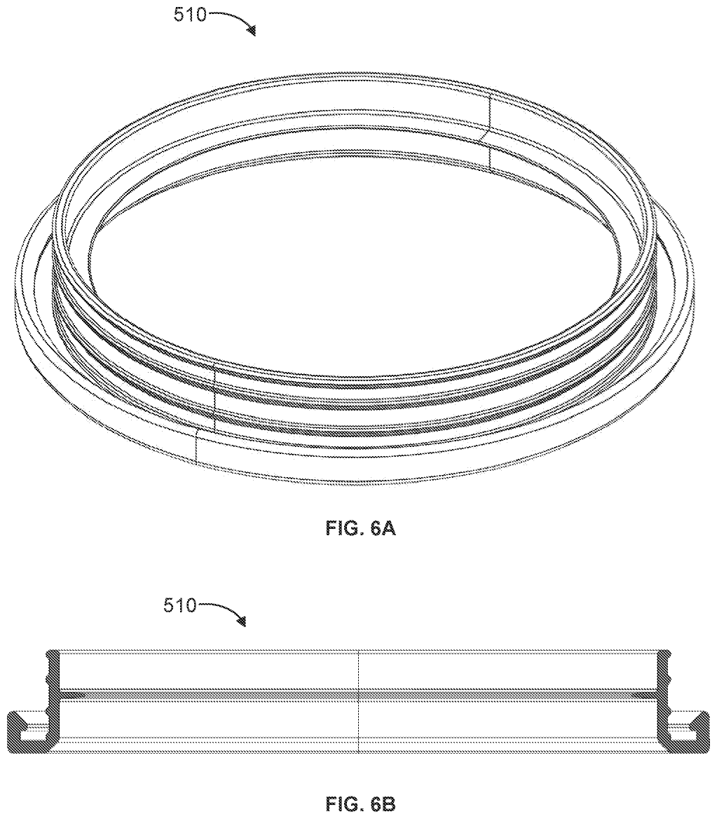

As shown in FIG. 5, the disclosed technology can include a fuel burning device housing 500. For example, the housing 500 can be at least a portion of a housing for a fuel burning device. The housing 500 can enclose at least a portion of a burner. Alternatively, or in addition, the housing 500 can include a flue gas outlet 520 in fluid communication with the burner. The housing 500 can be configured to attach to the inlet chamber 110. For example, the housing 500 can include a collar 530 that fits around a portion of the inlet chamber. Alternatively, or in addition, the housing 500 can include a gasket 510 (shown in FIGS. 6A and 6B) disposed between the collar 530 and the inlet chamber 110. The gasket 510 can create an airtight seal between the attached housing 500 and inlet chamber 110. The flue gas outlet 520 can be in fluid communication with the inlet chamber 110.

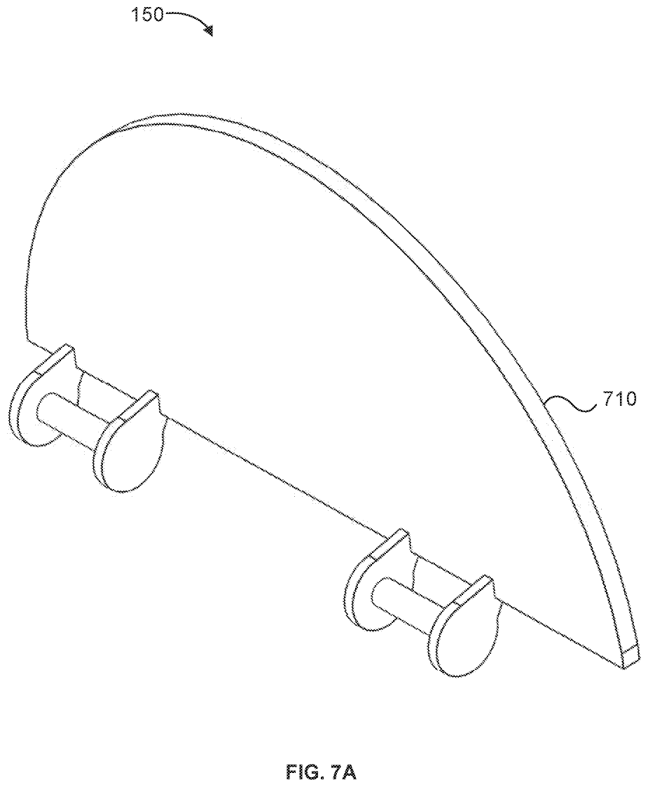

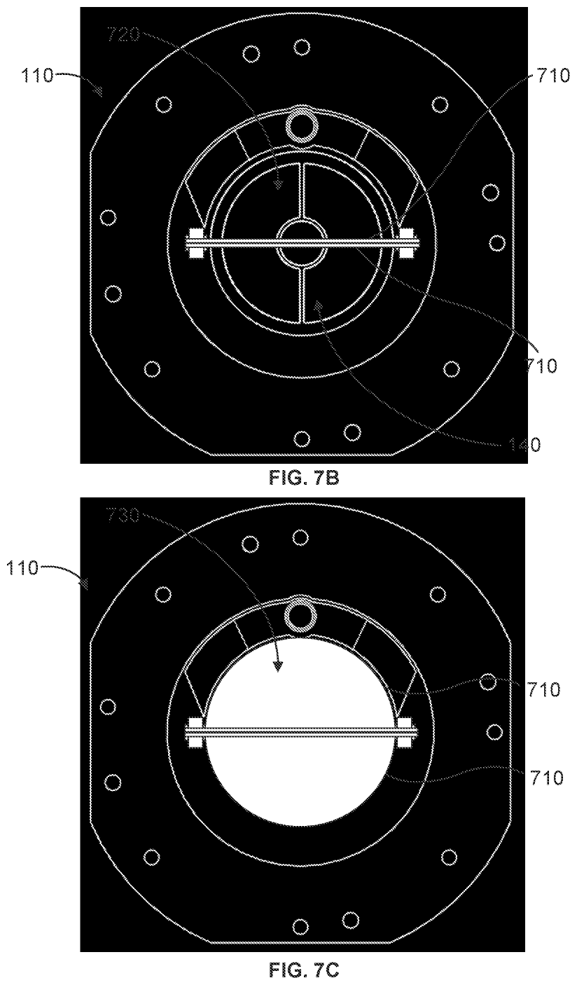

As shown in FIGS. 7A-7C, the door 150 can include one or more flaps 710. For example, as illustrated in FIGS. 1B-1D, the door 150 can include a single flap. As an alternative example, the door 150 can include two flaps 710, as illustrated in FIGS. 7B and 7C. The flaps 710 can be semicircular in shape. The flaps can be in a closed position 730 where the flaps 710 create a barrier between the inlet chamber 110 and the outlet chamber 120. The barrier created by the flaps 710 in the closed position 730 can prevent the flow of flue gas from the outlet chamber 120 to the inlet chamber 110. In addition, the flaps 710 can be configured to open. For example, the flaps 710 can be in an open position 720 where the flaps are rotated such that they no longer create a barrier between the inlet chamber 110 and the outlet chamber 120. The flaps 710 can open upon a flow of flue gas from the inlet chamber 110 to the outlet chamber 120.

The flaps 710 can be configured to bias closed. For example, the flaps 710 can be biased closed by gravity exerting a passive force on the flaps 710 to be in a closed position. The force of gravity can be overcome by the differential air pressure caused by the flow of flue gas from the inlet chamber 110 to the outlet chamber 120 to allow the flaps 710 to open. Alternatively, or in addition, the flaps 710 can biased closed by a spring. For example, the flaps 710 can include one or more spring members that can passively exert a force on the flaps 710 to be in a closed position. The spring member can exert a force that can be overcome by the differential air pressure caused by the flow of flue gas from the inlet chamber 110 to the outlet chamber 120 to allow the flaps 710 to open. Alternatively, or in addition, the flaps 710 can be motorized and controllably opened and closed. For example, the flaps 710 can be controlled by a controller, such as the controller described more fully herein.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A flue gas outlet assembly comprising:
a flue gas inlet configured to connect to an exhaust outlet of a fuel burning device;
a flue gas outlet; and
a flue pipe condensate drain assembly comprising:
a condensate inlet;
a condensate outlet; and
a float valve disposed between the condensate inlet and the condensate outlet, the float valve comprising a bullet-shaped float,
wherein the float valve is biased closed and is configured to open to permit a flow of condensate from the condensate inlet to the condensate outlet upon a sufficient amount of condensate collecting proximate the float valve.

2. The flue gas outlet assembly of claim 1, wherein the float valve is disposed at a location offset from a central axis of the flue gas inlet or a central axis of the flue gas outlet.

3. The flue gas outlet assembly of claim 1, wherein the float valve is disposed at a periphery of an internal volume of the flue gas inlet or an internal volume of the flue gas outlet.

4. The flue gas outlet assembly of claim 1, wherein the bullet-shaped float is hollow.

5. The flue gas outlet assembly of claim 4, wherein the bullet-shaped float comprises:
a first end that is open; and
a second end that is closed, the second end having a generally hemispherical shape.

6. The flue gas outlet assembly of claim 1, wherein the condensate outlet is fluidly coupled to a fuel burning device.

7. The flue gas outlet assembly of claim 6, wherein the condensate outlet discharges condensate into a condensate drain of the fuel burning device.

8. A fuel burning water heater comprising:
a housing comprising:
a burner disposed within the housing; and
a flue gas outlet disposed on the housing and in fluid communication with the burner; and
a flue gas outlet assembly affixed directly to the housing of the fuel burning water heater, the flue gas outlet assembly comprising:
an inlet chamber configured to receive flue gas from the flue gas outlet;
an outlet chamber; and
a door disposed between the inlet chamber and the outlet chamber, the door being configured to selectively permit the flue gas to flow between the inlet chamber and the outlet chamber,
wherein the door is configured to bias closed and to open upon a flow of flue gas from the inlet chamber to the outlet chamber.

9. The fuel burning water heater of claim 8, wherein the flue gas outlet assembly further comprises:
a flue pipe condensate drain assembly comprising:
a condensate inlet;
a condensate outlet; and
a float valve disposed between the condensate inlet and the condensate outlet,
wherein the float valve is biased closed and is configured to open to permit a flow of condensate from the condensate inlet to the condensate outlet upon a sufficient amount of condensate collecting proximate the float valve.

10. The fuel burning water heater of claim 9, wherein the float valve is disposed at a location offset from a central axis of the inlet chamber or a central axis of the outlet chamber.

11. The fuel burning water heater of claim 9, wherein the float valve is disposed at a periphery of an internal volume of the inlet chamber or an internal volume of the outlet chamber.

12. The fuel burning water heater of claim 9, wherein the float valve comprises a bullet-shaped float.

13. The fuel burning water heater of claim 12, wherein the bullet-shaped float is hollow.

14. The fuel burning water heater of claim 13, wherein the bullet-shaped float comprises:
a first end that is open; and
a second end that is closed, the second end having a generally hemispherical shape,
wherein the first end is disposed proximal to the outlet chamber and the second end is disposed distal the outlet chamber.

15. The fuel burning water heater of claim 8, wherein the door comprises a plurality of flaps.

16. The fuel burning water heater of claim 8, wherein the door is a circular door comprising a semicircular first flap and a semicircular second flap.

17. The fuel burning water heater of claim 8, wherein the outlet chamber is fluidly coupled with one or more additional fuel burning devices.

18. The fuel burning water heater of claim 8, wherein the outlet chamber is fluidly coupled with a common vent manifold configured to exhaust flue gas from the fuel burning water heater and one or more additional fuel burning devices.

19. A water heater system comprising:
a common vent manifold configured to exhaust flue gas; and
a plurality of fuel burning water heaters, each of the plurality of fuel burning water heaters comprising:
a housing comprising:
a burner disposed within the housing; and
a flue gas outlet disposed on the housing and in fluid communication with the burner;
a flue gas outlet assembly affixed directly to the housing of at least one of the fuel burning water heaters, the flue gas outlet assembly comprising:
an inlet chamber configured to receive flue gas from the flue gas outlet;
an outlet chamber; and
a door disposed between the inlet chamber and the outlet chamber, the door being configured to selectively permit the flue gas to flow between the inlet chamber and the outlet chamber,
wherein the door is configured to bias closed and to open upon a flow of flue gas from the inlet chamber to the outlet chamber; and
a flue pipe condensate drain assembly comprising:
a condensate inlet;
a condensate outlet; and
a float valve disposed between the condensate inlet and the condensate outlet,
wherein the float valve is biased closed and is configured to open to permit a flow of condensate from the condensate inlet to the condensate outlet upon a sufficient amount of condensate collecting proximate the float valve.

20. The water heater system of claim 19, wherein the float valve comprises a bullet-shaped float.
